(19) United States
(12) Patent Application Publication
(10) Pub. No.: US 2005/0041387 A1
(43) Pub. Date: Feb. 24, 2005

(54) Enclosure having a light source

(76) Inventor: Tzen-Chin Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/642,787

(22) Filed: Aug. 19, 2003

(51) Int. Cl. G06F 1/16

(52) U.S. Cl. 361/685

(57) ABSTRACT

An enclosure having a light source is applied to a storage device, and is used for data transmission between a computer and the storage device. A light-emitting unit is provided on a main body of the enclosure. A circuit control module is provided inside the main body, and is used to control data transmission format conversion and radiation variation of the light-emitting unit and let the radiation of the light-emitting unit vary according to the data transmission status of the storage device. The data transmission status between the storage device and the computer can thus be reflected through the color variation of the light-emitting unit.

### FIELD OF THE INVENTION

The present invention relates to an enclosure having a light source and, more particularly, to an enclosure used for a storage device and capable of emitting light.

### BACKGROUND OF THE INVENTION

Existent 3.5″ 1.44 MB floppy disks are portable storage media that have been used for the longest time. However, because of their small storage capacity, they do not conform to the recent trend of high storage capacity. Therefore, various kinds of portable storage media have been proposed, and the transmission interfaces thereof differ. For instance, although plug-and-play flash memories have the advantages of small size and high transmission speed, their storage capacity does not compare to that of hard discs and compact discs.

Therefore, hard disk or compact disc (CD) enclosures are widely used at present. A transmission line is connected between an enclosure and a computer in a simple connection way to let a user have a storage space with a large capacity. In other words, the user need not dismantle the computer case to install a hard disk drive or a CD drive, hence saving the installation time. The user can thus go anywhere taking the hard disk drive or CD drive with him. However, although the conventional enclosure permits the user to connect externally a hard disk drive or a CD drive to a computer quickly, it has no light-emitting function to enhance the interactive effect during operation and

### SUMMARY OF THE INVENTION

The primary object of the present invention is to provide an enclosure having a light source to provide the enclosure with a light-emitting function and reflect the present operational status of the enclosure through color variations of light.

To achieve the above object, the present invention provides an enclosure having a light source. The enclosure applies to a storage device, and is used for data transmission between the storage device and a computer. The enclosure having a light source comprises a main body and a light-emitting unit. The light-emitting unit is disposed on the main body. The present data transmission status of the enclosure can thus be reflected through color variations of the light-emitting unit.

### BRIEF DESCRIPTION OF THE DRAWINGS

The various objects and advantages of the present invention will be more readily understood from the following detailed description when read in conjunction with the appended drawing, in which:

FIG. 1 is a front view according to the best embodiment of the present invention;

FIG. 2 is rear view according to the best embodiment of the present invention;

FIG. 3 is a circuit diagram of the present invention; and

FIG. 4 is a diagram showing the present invention connected to a computer for data transmission.

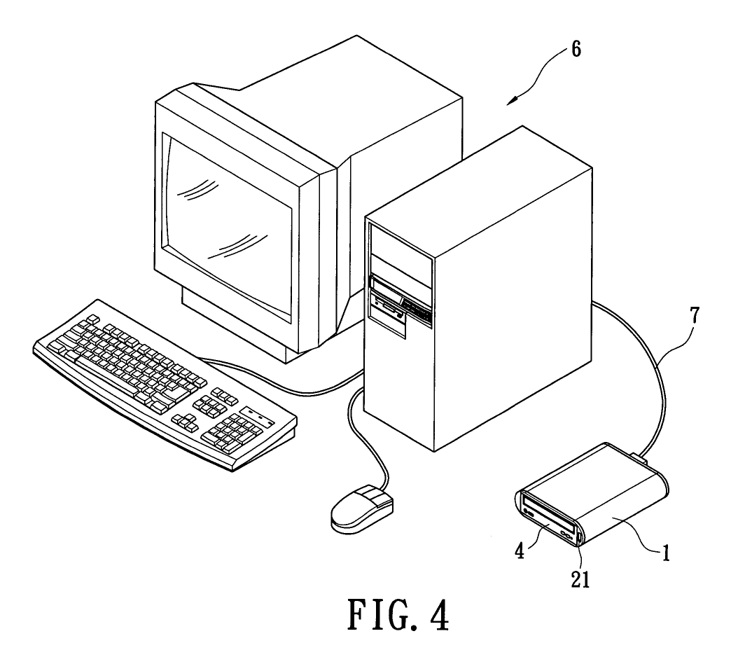

### DETAILED DESCRIPTION OF THE PREFERRED EMBODIMENTS

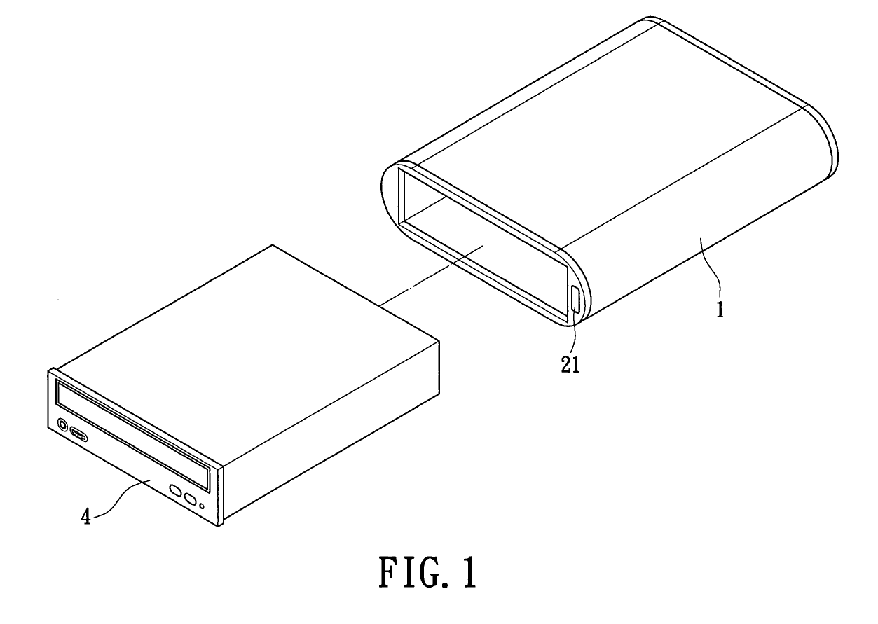

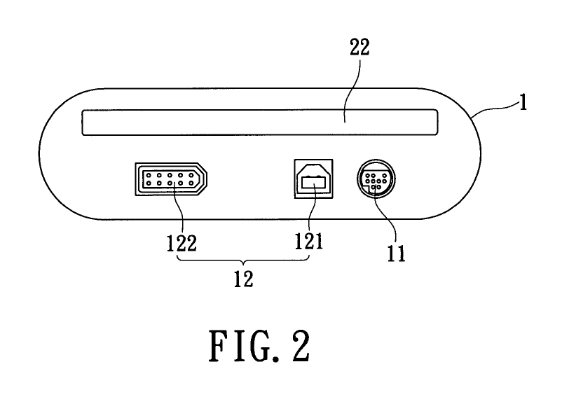

As shown in FIGS. 1, 2 and 3, the present invention provides an enclosure having a light source, which is applicable to a storage device 4 and used for data transmission between the storage device 4 and a computer. The storage device 4 can be a hard disk drive or a CD drive. In this embodiment, the storage device is a CD drive.

The enclosure having a light source comprises a main body 1 and a light-emitting unit 2. A power socket 11 and a transmission interface 12 are provided at the rear side of the main body 1. The power socket 11 is used to let an external power supply 5 provide electric power for the storage device 4. The transmission interface 1 is a dual interface supporting a universal serial bus (USB) interface 121 and an IEEE 1394 interface 122.

In this embodiment, the light-emitting unit 2 comprises a first light-emitting component 21 at the front side of the main body 1 and a second light-emitting component 22 at the rear side of the main body 1. The first light-emitting component 21 is an RGB light-emitting diode (LED) capable of emitting light of red, green and blue colors. The second light-emitting component 22 is a strip-shaped graph display 22 capable of emitting light of red, green and blue colors. The first and second light-emitting components 21 and 22 can generate colorful effects through a mixture of red, green and blue colors.

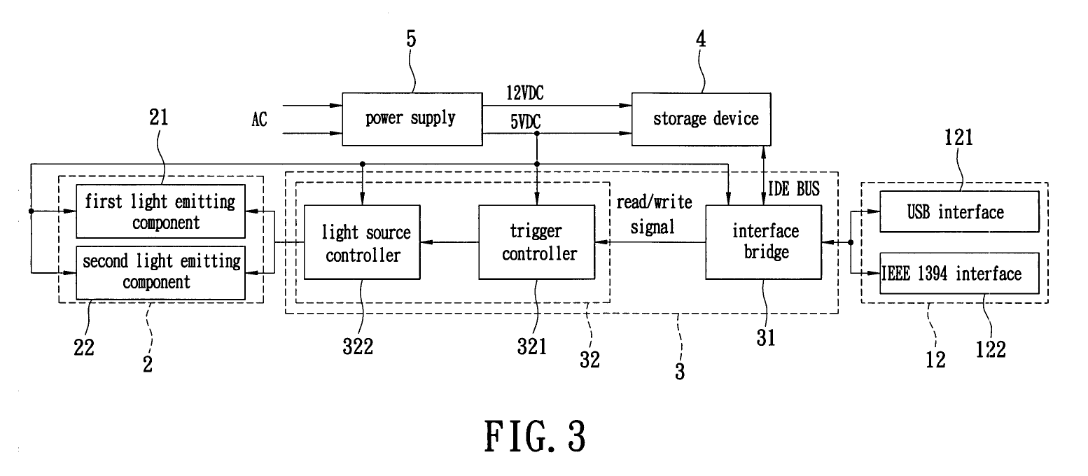

As shown in FIG. 3, a circuit control module 3 is provided inside the main body 1. An interface bridge 31 in the circuit control module 3 is connected between the transmission interface 12 and the storage device 4 and used for data transmission format conversion. The transmission between the interface device electronics (IDE) interface. The interface 31 can thus convert transmission data of the USB interface 121 or the IEEE 1394 interface 122 into data format suitable for the IDE interface.

A light emission drive module 32 is connected between the interface bridge 31 and the light-emitting unit 2, and is used to drive the light-emitting unit 2. The light emission drive module 32 is composed of a trigger controller 321 and a light source controller 322. The trigger controller 321 is used to generate an ENABLE signal to the light source controller 322. The light source controller 322 is used to control light emission of the light-emitting unit 2. Because the interface bridge 31 generates read/write signals during data transmission, the trigger controller 321 generates an ENABLE signal to the light source controller 322 according to the read/write signal of the interface bridge 31. After receiving the ENABLE signal, the light source controller 322 fixes the color of the light-emitting unit 2 (e.g., red). Before receiving the ENABLE signal, the light source controller 322 allows the light-emitting unit 2 to show alternating variations of red, green and blue colors.

A power supply 5 in FIG. 3 provides 12VDC and 5VDC voltage outputs for the storage device 4, the circuit control module 3 and the light-emitting unit 2.

In other words, the interface bridge 31 of the circuit control module 3 is used for data transmission format conversion. The light emission drive module 32 of the circuit control module 3 is used to drive the light-emitting unit 2 to generate color variations according to the data transmission status of the interface bridge 31.

As shown in Fig. A, the main body 1 is connected to a computer 6 by a connection line 7 so that the computer 6 can read data from the storage device 4 (i.e., the CD drive) inside the main body 1. When the computer 6 is reading data from the storage device 4, the first light-emitting component 21 emits a red light. When the computer is not reading data from the storage device 4, the first light-emitting component 21 shows alternating variations of red, green and blue colors. Similarly, the second light-emitting component 22 (not shown) at the rear side of the main body 1 can display light color variations along with the first light-emitting component 21.

A single light color displayed by the light-emitting unit 2 indicates that data transmission is proceeding between the computer 6 and the storage device 4. Varying colors of light displayed by the light-emitting unit 2 indicates that no data transmission is occurring between the computer 6 and the storage device 4.

To sum up, the enclosure having a light source of the present invention has the following characteristics:
1. The present operational status of the storage device can be known according to the light color variation of the light-emitting unit.
2. The enclosure combined with the light-emitting unit provides the enclosure with a novel visual effect.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. An enclosure having a light source applicable to a storage device and used for data transmission between said storage device and a computer, said enclosure comprising:
a main body; and
a light-emitting unit provided on said main body.

2. The enclosure having a light source as claimed in claim 1, wherein a power socket is provided on said main body.

3. The enclosure having a light source as claimed in claim 1, wherein a transmission interface is provided on said main body.

4. The enclosure having a light source as claimed in claim 3, wherein said transmission interface is a universal serial bus interface.

5. The enclosure having a light source as claimed in claim 3, wherein said transmission interface is an IEEE 1394 interface.

6. The enclosure having a light source as claimed in claim 1, wherein said light-emitting unit comprises a first light-emitting component at a front side of said main body and a second light-emitting component at a rear side of said main body.

7. The enclosure having a light source as claimed in claim 6, wherein said first light-emitting component is an RGB light-emitting diode.

8. The enclosure having a light source as claimed in claim 6, wherein said second light-emitting component is a graph display.

9. The enclosure having a light source as claimed in claim, 1 further comprising a circuit control module inside said main body, said circuit control module comprising:
an interface bridge connected between said storage device and said computer and used for data transmission format conversion; and
a light emission drive module connected between said interface bridge and said light-emitting unit and used to drive said light-emitting unit.

10. The enclosure having a light source as claimed in claim 9, wherein the transmission between said interface bridge and said storage device is accomplished via an integrated device electronics interface.

11. The enclosure having a light source as claimed in claim 9, wherein said light emission drive module comprises:
a trigger controller used to generate an ENABLE signal according to a read/write signal of said interface bridge; and
a light source controller used to receive said ENABLE signal for controlling color variations of said light-emitting unit.

12. The enclosure having a light source as claimed in claim 1, wherein said storage device is a hard disk drive.

13. The enclosure having a light source as claimed in claim 1, wherein said storage device is a compact disc drive.
